(19) United States
(12) Patent Application Publication
(10) Pub. No.: US 2012/0164900 A1
(43) Pub. Date: Jun. 28, 2012

(54) COATED REINFORCEMENT

(76) Inventors: Heinz-Gunter Reichwein, Kamp-Lintfort (DE); Tareq Hasson, Ratingen (DE); Dirk Ewald, Haltern am See (DE)

(21) Appl. No.: 13/387,643

(22) PCT Filed: Jul. 22, 2010
(86) PCT No.: PCT/EP2010/004483

§ 371 Date: Mar. 2, 2012

(30) Foreign Application Priority Data
Aug. 5, 2009 (DE) 10 2009 036 120.0

(51) Int. Cl. B32B 5/02; B32B 17/10; B32B 18/00; C08K 3/04; C08K 3/08; C08K 3/22; B05D 7/00; D03D 9/00; B32B 9/04; B82Y 30/00

(52) U.S. Cl. 442/1; 442/59; 428/426; 428/446; 428/688; 523/468; 523/457; 427/195; 977/742; 977/783

(57) ABSTRACT

The invention relates to the providing of a coated reinforcement, coating thereof ultimately allowing for the providing of a fiber-reinforced product, particularly in the infusion method, having exceptional mechanical properties, wherein the composition of the coating comprises a solid resin and carbon nanotubes and said composition has been subjected to heat treatment above the melting temperature of the softening range and below the cross-linking temperature of the solid resin, which is self-crosslinking as applicable, wherein the composition is fixed on the surface of the reinforcement.

This application claims the benefit of PCT Application PCT/EP2010/004483 with International Filing Date of Jul. 22, 2010, published as WO2011/015288 A1, which further claims priority to German Patent Application No. 102009036120.0 filed Aug. 5, 2009, the entire contents of both are hereby incorporated by reference.

The invention relates to a coated reinforcement and to its use.

If reinforcements are to be coated with a resin, there are various requirements that must be taken into account in terms of the reinforcement and of the resin. The aim is to obtain a product which ultimately has a mechanical resistance sufficient for the specific application. Furthermore, the reinforcement should be able to be coated without complication and in as short a time as possible. However, there are barriers to the conventional techniques for the coating of the reinforcements, since the nature of the mixture and the composition of the mixture impose technical limits on processing.

Conventionally, reinforcements can be coated using hand lamination technology, using prepreg technology or else by means of an infusion technique. For the coating of reinforcements by means of an infusion technique, only resin mixtures having corresponding properties can be used, these resins firstly allowing the method to be carried out at all (easy injectability, viscosity) and secondly leading to products having desired mechanical or chemical properties. Accordingly, resin mixtures on the basis of polyesters, vinyl esters, and epoxides are commonplace.

Where conventional resin mixtures on the basis of epoxides, for example, are to be used for the infusion method, they are indeed easy to inject, but generally give the end product an inadequate impact toughness and damage tolerance with respect to impact effects, these qualities nevertheless being a requirement for numerous applications.

In order to improve the impact toughness of resins one known measure is to mix soft, pulverulent fillers, such as finely ground rubber, for example, into the infusion resin mixtures. EP 1375591 B1 describes the use of crosslinkable elastomer particles based on polyorganosiloxanes for resin mixtures which can be processed in the RTM method. With such a measure, however, the mechanical properties are still not sufficiently improved. Moreover, the use of solid particles in the infusion method has to date meant that the solid particles were unable to penetrate the fiber material. The consequence was that the fiber material could not be coated with a homogeneous resin mixture, and this had adverse effects on the properties, more particularly on the mechanical properties, of the end product.

It is also known that the properties of thermosetting resins can be influenced positively by means of carbon nanotubes. Accordingly, the conductivity or else the mechanical properties, such as impact toughness or elongation at break, of thermosetting resins filled with carbon nanotubes can be improved (e.g., WO 2007/011313 or Li Dan; Zhang, Xianfeng et al.: Toughness improvement of epoxy by incorporating carbon nano tubes into the resin, Journal of Materials Science Letters (2003), 22(11), 791-793. ISSN:0261-8028). The properties and the production of the carbon nanotubes are likewise known from the prior art (e.g.: Wissenschafftliche Zeitschrift der Technischen Universiftät Dresden, 56 (2007), volume 1-2, Nanowelt). Carbon nanotubes are microscopically small, tubular structures made of carbon. There are single-wall or multiwall, open or closed or filled carbon nanotubes. The diameter of the nanotubes is between 0.2 and 50 nm, and the length varies from a few millimeters up to presently 20 cm. Carbon nanotubes are obtainable from, for example, SES Research, Houston, USA or CNT Co. Ltd., Korea. If, however, such carbon nanotubes are used for compositions for producing fiber-reinforced products, particularly by the infusion method, the difficulties that occur have been the same as those also occurring hitherto with the use of other solid particles in the resin mixture (nonpenetration of the fiber material and hence inhomogeneous coating). The carbon nanotubes have therefore been unable to develop their properties in the context of the use of fiber-reinforced products produced at least by the infusion method.

It is now an object of the present invention to provide coated reinforcements whose coating ultimately makes it possible to provide a fiber-reinforced product, more particularly by the infusion method, that possesses outstanding mechanical properties.

This object is achieved by virtue of the fact that the surface of the reinforcement has a coating of a composition which is composed of a solid resin and carbon nanotubes, and this composition has been subjected to a heat treatment above the melting temperature or the softening range and below the crosslinking temperature of the optionally self-crosslinking solid resin, the composition as a result being fixed on the surface of the reinforcement.

The reinforcement of the invention is coated with a mixture of solid resin and carbon nanotubes.

The solid resin may be selected, for example, from phenolic resins (novolaks, resoles), polyurethanes, polyolefins, with particular preference epoxy resins, phenoxy resins, vinyl ester resins, polyester resins, cyanate ester resins, bismaleimide resins, benzoxazine resins and/or mixtures hereof. It is, however, also possible to use other solid resins known from the prior art. The glass transition temperature (melting temperature) is preferably T_{g}>50° C. The T_{g} value is reported for primarily thermoset materials. Where the solid resins are primarily thermoplastic materials, the softening range is to be preferably (Tₘ)>50° C. The use of resins having a T_{g}/Tₘ<50° C. is less suitable under certain circumstances for the coating of reinforcements in accordance with the invention, since the resin, depending on type, becomes of increasingly low viscosity, meaning that it would penetrate the reinforcement and the solid particles (carbon nanotubes) in the composition would remain on the surface of the reinforcement. A homogeneous surface coating of the reinforcement would therefore not be ensured.

The use of the preferred solid resins—epoxy resins, phenoxy resins, vinyl ester resins, polyester resins, cyanate ester resins, bismaleimide resins, benzoxazine resins and/or mixtures hereof—has the advantage that these solid resins possess particular thermal and mechanical stability and also good creep resistance.

It is particularly preferred for the composition to comprise at least one resin selected from the group of the polyepoxides on the basis of bisphenol A and/or F and advancement resins prepared therefrom, on the basis of epoxidized halogenated bisphenols and/or epoxidized novolaks and/or polyepoxide esters on the basis of phthalic acid, hexahydrophthalic acid or on the basis of terephthalic acid, epoxidized o- or p-aminophenols, epoxidized polyaddition products of dicyclopentadiene and phenol. As resin component, accordingly, use is made of epoxidized phenol novolaks (condensation product of phenol and, for example, formaldehyde and/or glyoxal), epoxidized cresol novolaks, polyepoxides on the basis of bisphenol A (e.g., including product of bisphenol A and tetraglycidylmethylenediamine), epoxidized halogenated bisphenols (e.g., polyepoxides on the basis of tetrabromobisphenol A) and/or polyepoxides on the basis of bisphenol F and/or epoxidized novolak and/or epoxy resins based on triglycidyl isocyanurates.

The average molecular weight of all of these resins is ≧600 g/mol, since they are then solid resins, which preferably can be applied by scattering. Such resins include, among others:
Epikote® 1001, Epikote® 1004, Epikote® 1007, Epikote® 1009: polyepoxides based on bisphenol A,
Epon® SU8 (epoxidized bisphenol A novolak) Epon® 1031 (epoxidized glyoxal-phenol novolak), Epon® 1163 (polyepoxide on the basis of tetrabromobisphenol A), Epikote® 03243/LV (polyepoxide on the basis of (3,4-epoxycyclohexyl)methyl, 3,4-epoxycyclohexylcarboxylate and bisphenol A),
Epon® 164 (epoxidized o-cresol novolak)—all products available from Hexion Specialty Chemicals Inc.

The advantage of these solid resins used is that they are storable and grindable at room temperature. They are meltable at moderate temperatures. They give the reinforcement good mechanical resistance. Furthermore, they are compatible with other resins used, for example, in the production of fiber-reinforced product. In comparison to polyesters and vinyl esters, in addition, for example, epoxy resins have the particular advantage that they exhibit low contraction values, and this in general has a positive influence on the mechanical characteristics of the end product.

For producing the coated reinforcements of the invention it is possible to use any of a wide variety of carbon nanotubes, the intention being that the structure of the carbon nanotubes should be adapted to the structure of the solid resin, in order to obtain a mixture which can be produced as easily as possible.

Generally speaking, a mixture of solid resin and carbon nanotubes can be obtained by producing a premix in a standard stirrer and subsequently homogenizing the mixture in an ultrasound bath. Corresponding methods are, for example, in Koshio, A. Yudasaka, M. Zhang, M. Iijima, S. (2001): A simple way to chemically react single wall carbon nanotubes with organic materials using ultrasonication; in nano letters, Vol. 1, No. 7, 2001, pp. 361-363, American Chemical Society (Database CAPLUS: AN 2001:408691) or Paredes, J. I. Burghard, M. (2004): Dispersions of individual single walled carbon nanotubes of high length in: Langmuir, Vol. 20, No. 12, 2004, 5149-5152, American Chemical Society (Database CAPLUS: AN 2004:380332).

It is also possible to incorporate the carbon nanotubes into the solid resin by melting the solid resin, dispersing the carbon nanotubes, and subsequently extruding the dispersion.

In the mixture the carbon nanotubes are present in a concentration of 0.2% to 30% by weight, based on the weight of the solid resin in the composition. At concentrations <0.2% by weight, the effect achieved is not sufficient; at concentrations >30% by weight, processing-related disadvantages are anticipated in terms of the homogeneity of the composition, and this could ultimately lead to detractions from the mechanical properties of the fiber-reinforced product. Particularly preferred is a range between 0.2% and 5% by weight for carbon nanotubes, since the production of the composition can proceed on account of the, for example, low level of introduction of shearing forces.

It is possible, furthermore, for the composition of the coating to comprise a solid resin, carbon nanotubes, and further additives and for this composition to have been subjected to a heat treatment above the melting temperature or the softening range of the solid resin and below the crosslinking temperature of the optionally crosslinking composition, the composition being fixed on the surface of the reinforcement.

If the composition comprises a curing agent (crosslinking agent) as further additive, leading to an advantageous reduction in the temperature of the heat treatment required, the curing agent in question may be one which is known from the prior art for the resin in question.

For epoxy resins, for example, curing agents considered include phenols, imidazoles, thiols, imidazole complexes, carboxylic acids, boron trihalides, novolaks, and melamine-formaldehyde resins. Particularly preferred are anhydride curing agents, preferably dicarboxylic anhydrides and tetracarboxylic anhydrides, and/or modifications thereof. Examples that may be given at this point include the following anhydrides: tetrahydrophthalic anhydride (THPA), hexahydrophthalic anhydride (HHPA), methyltetrahydrophthalic anhydride (MTHPA), methylhexahydrophthalic anhydride (MHHPA), methylnadic anhydride (MNA), dodecenylsuccinic anhydride (DSA) or mixtures thereof. Modified dicarboxylic anhydrides employed include acidic esters (reaction products of abovementioned anhydrides or mixtures thereof with diols or polyols, e.g.: neopentyl glycol (NPG), polypropylene glycol (PPG, preferably molecular weight 200 to 1000). Through skilled modification it is possible to set a wide range for the glass transition temperature (between 30 and 200° C.). Furthermore, the curing agents may be selected from the group of the amine curing agents, selected in turn from these from the polyamines (aliphatic, cycloaliphatic or aromatic), polyamides, Mannich bases, polyaminoimidazoline, polyetheramines, and mixtures hereof. Mention may be made at this point, by way of example, of the polyether amines, e.g., Jeffamines D230, D400 (from Huntsman), the use of which gives the curing process a slight exothermic nature. The polyamines, isophorone diamine for example, give the composition a high T_{g}, and the Mannich bases, e.g., Epikure 110 (Hexion Specialty Chemicals Inc.) are notable for low carbamate formation and for high reactivity.

As a further additive, the composition may comprise a component which accelerates the crosslinking. Suitable in principle are all accelerators known from the prior art which can be used for such resins. By way of example, mention may be made here of accelerators for epoxy resins, these being, for example, imidazoles, substituted imidazoles, imidazole adducts, imidazole complexes (e.g., Ni-imidazole complex), tertiary amines, quaternary ammonium and/or phosphonium compounds, tin(IV) chloride, dicyandiamide, salicylic acid, urea, urea derivatives, boron trifluoride complexes, boron trichloride complexes, epoxy addition reaction products, tetraphenylene-boron complexes, amine borates, amine titanates, metal acetylacetonates, metal salts of naphthenic acids, metal salts of octanoic acids, tin octoates, other metal salts and/or metal chelates, for use.

Mention may additionally be made at this point, by way of example, of the following: oligomeric polyethylene piperazines, dimethylaminopropyldipropanolamine, bis(dimethylaminopropyl)amino-2-propanol, N,N′-bis(3-dimethylaminopropyl)urea, mixtures of N-(2-hydroxypropyl)imidazole, dimethyl-2-(2-aminoethoxy)ethanol and mixtures hereof, bis(2-dimethylaminoethyl) ether, pentamethyldiethylenetriamine, dimorpholinodiethyl ether, 1,8-diazabicyclo[5.4.0]undec-7-ene, N-methylimidazole, 1,2-dimethylimidazole, triethylenediamine, 1,1,3,3-tetramethylguanidine.

The composition may further comprise further additives such as, for example, graphite powders, siloxanes, pigments, metals (e.g., aluminum, iron or copper) in powder form, preferably particle size <100 μm, or metal oxides (e.g., iron oxide), reactive diluents (e.g., glycidyl ethers on the basis of fatty alcohols, butanediol, hexanediol, polyglycols, ethylhexanol, neopentyl glycol, glycerol, trimethylolpropane, castor oil, phenol, cresol, p-tert-butylphenol), UV protectants or processing assistants. These additives are added, based on the solid resin, in a usual concentration from 1% to 20% by weight, based on the weight of the resin. The use of graphite, metals or metal oxide makes it possible on account of their conductivity for the mixture in question to undergo inductive heating, thus resulting in a significant reduction in the cure time. Siloxanes have an influence on improved impregnation and fiber attachment, leading ultimately to a reduction in the defect sites in the assembly. Moreover, siloxanes act acceleratingly in the infusion procedure.

In summary it can be stated that these additives serve as processing assistants and/or for stabilizing the mixtures, or as colorants.

Together with the carbon nanotubes and the solid resins listed above, the additives produce solid, preferably free-flowing or scatterable mixtures which at room temperature possess a sufficient to outstanding storage stability.

The reinforcements may be selected from glass, ceramic, boron, carbon, basalt, synthetic and/or natural polymers and may be used in the form of fibers (e.g., short fibers or continuous fibers), scrims, nonwovens, knits, random-laid fiber mats and/or wovens.

The composition for the coating of the reinforcements may be applied in a conventional way in the form, for example, of scattering, spraying, spreading, knife-coating or by means of an infusion technique. Application by scattering is preferred, since the material is already per se preferably a powder and therefore can be used without complication. In accordance with the solid resin or solid resin/additive mixture that is used, the temperature (preferably about 50-150° C.) of the heat treatment is selected such that a film of the melted composition remains on the surface of the reinforcement. Where thermosetting materials are used, they are still in a noncrosslinked state, since the temperature chosen for the heat treatment is below the crosslinking temperature (curing temperature). Where the heat treatment is carried out at or above the crosslinking temperature of the solid resin, said resin is no longer sufficiently capable of entering into a chemical reaction with other resins, which are necessary, for example, for producing a fiber-reinforced product, and attachment would be weakened. The heat treatment may be carried out, for example, in a continuous oven. The heat treatment preferably takes place in the cavity of the immediately following infusion method, thereby substantially reducing the production time for a component comprising the coated reinforcement.

The composition is storage-stable, and can therefore be premixed and used as and when required. Another advantage is that the coated reinforcement as well is storage-stable, and so can be supplied to the further production site in a prefabricated form. Optionally after storage the coated reinforcement is subjected to space-saving roll-up and/or preforming and/or transportation. Furthermore, the coating increases the drapability and improves the trimming of the reinforcement.

The reinforcement coated in accordance with the invention for producing products for industrial applications (e.g., pipes), for the production of rotor blades for wind turbines, in aircraft and vehicle technology, in automobile construction, for sports articles, and in marine construction.

The reinforcement coated in accordance with the invention is suitable for a method for producing a fiber-reinforced product, comprising the following steps:
a) producing a coated reinforcement of at least one of claims 1 to 8 and optionally preforming in one or more layers of the coated reinforcement,
b) contacting the coated reinforcement with a resin which is liquid at processing temperatures, and
c) curing the assembly at optionally elevated temperature under increased or reduced pressure.

It is possible for processable liquid resin to be applied by spreading, spraying, knife-coating or similar processes.

Particularly preferred, however, are processes in which the processable liquid resin is contacted with the coated reinforcement by means of infusion methods. In this case, the coated reinforcements are generally preformed in such a way that they can be inserted directly into the cavity of the mold. The preforming of the coated reinforcements has the advantage that they can be deformed even more effectively than at a later stage. The resin is subsequently injected into the mold, in a low-viscosity state. There are a multiplicity of different resin injection methods, which are summarized under the heading Liquid Composite Molding (LCM). These methods include, among others, the SRIM (Structural Reaction Injection Molding) method, in which the resin is injected into the cavity under high pressure (>20 bar). This method, however, is suitable only for products which have a low fiber fraction, since the resin stream presses the fibers away from the gate area.

In the case of the RTM method, the substantially dry fiber material (e.g., glass fiber, carbon fiber or aramid fiber) is inserted in the form of wovens, braids, scrims, random-laid fiber mats or nonwovens into the mold. Preference is given to the use of carbon fibers and glass fibers.

The fiber material is preformed, corresponding at its most simple to a precompression of the fiber material provided with the surface coating of the invention, in order to keep this fiber material in shape in a storage-stable way. Prior to the insertion of the fiber material, the mold is treated with antistick agents (release agents). This may be a solid Teflon layer or else an agent applied correspondingly before each component manufacturing procedure. The mold is closed and the low-viscosity resin mixture is injected into the mold at a customary pressure (<6 bar). Accordingly, the low-viscosity resin is able to flow slowly through the fibers, producing a homogeneous impregnation of the fiber material. When a riser allows the resin fill level in the mold to be recognized, injection is terminated. This is followed by curing of the resin in the mold, generally assisted by the heating of the mold. When curing or crosslinking is at an end, the component may be removed, by assistance from ejector systems, for example.

Vacuum infusion methods are considered generally to be processes in which a reinforcement is placed into a coated mold and the mold is filled, as a result of the difference between vacuum and ambient pressure, by the infusion of a liquid matrix. Using a vacuum sealing strip, the film is sealed against the mold and the component is then evacuated with the aid of a vacuum pump. The air pressure presses the inserted parts together and fixes them. The temperature-conditioned liquid resin is drawn by suction, as a result of the applied vacuum, into the fiber material. Heating of the mold causes the liquid matrix component to cure.

An example of a vacuum infusion method is considered to be the VARI (Vacuum Assisted Resin Infusion) process, where the low-viscosity resin is drawn by vacuum into the cavity of the mold and hence through the fiber material, allowing the production of components having a very low air content. Since with this process the cavity need not be of pressure-resistant design on all sides, the mold costs are lower by comparison with the RTM process, although the time for producing a component is higher in the VARI process. One specific variant of the VARI process is the SCRIMP (Seeman Composite Resin Transfer Molding) Process. With this process, the low-viscosity resin is distributed at the same time over a large area by way of a system of channels which are present in a sheet. As a result, the impregnating time is substantially reduced, and at the same time air inclusions in the component are avoided.

The resin which is liquid at processing temperature has a preferred T_{g} or Tₘ <20° C. and may preferably be selected from the group consisting of epoxy resins, phenoxy resins, vinyl ester resins, polyester resins, cyanate ester resins, bismaleimide resins, benzoxazine resins and/or mixtures hereof. In general, however, it is possible to use all of the infusion resins known from the prior art.

With particular preference, the use of the polyepoxides is on the basis of bisphenol A and/or F, on the basis of tetraglycidylmethylenediamine (TGMDA), on the basis of epoxidized halogenated bisphenols (e.g., tetrabromobisphenol A) and/or epoxidized novolak and/or polyepoxide esters on the basis of phthalic acid, hexahydrophthalic acid or on the basis of terephthalic acid, epoxidized o- or p-aminophenols, epoxidized polyaddition products of dicyclopentadiene and phenol, diglycidyl ethers of the bisphenols, more particularly of bisphenols A and F, and/or advancement resins prepared therefrom, and comprises an anhydride curing agent and/or amine curing agent, and this assembly is cured under hot conditions. The epoxide equivalent weight of the resins is preferably 80-450 g. Mention may also be made at this point, by way of example, of 2,2-bis[3,5-dibromo-4-(2,3-epoxypropoxy)phenyl]propane, 2,2-bis[4-(2,3-epoxypropoxy)cyclohexyl]propane, 4-epoxyethyl-1,2-epoxycyclohexane or 3,4-epoxycyclohexyl 3,4-epoxycyclohexanecarboxylate [2386-87-0].

These mixtures are preferably of low viscosity in order to ensure simple injection.

Furthermore, the resin which can be processed in liquid form may comprise other customary additives, as already described for the solid resins. It is preferred if the solid resins and the liquid resins derive from the same chemical basis, since then the compatibility of the two resins is particularly good and it is possible to rule out any adhesion problems occurring.

The assembly produced using the reinforcement coated in accordance with the invention is cured under hot conditions at about 40-200° C., preferably 80-140° C., adapted in line with the resins used and processes employed.

The invention will be illustrated in more detail by reference to a working example.

### a) Preparation of the Composition of the Mixture for the Coating of the Reinforcement

### Resin/Nanotubes Mixture:

20 g of a solid epoxy resin (Epikote® 1004—product available from Hexion Specialty Chemicals Inc.) are melted at 120° C. in a heatable container and 0.2 g of MW CNT (BAYTUBES—BAYER Material Science) is added and the mixture is mixed mechanically using a laboratory mixer. The homogeneous dispersion of the matrix takes place with the aid of an Ultrax. The matrix (epoxy-MWCNT) is cooled and finely ground with the aid of a laboratory mill.

This mixture is scattered onto a woven glass filament fabric and subjected at about 80 to 120° C. to a heat treatment, and so the mixture is fixed by melting of the solid resin on the surface of the fabric.

b) Production of the Product by the Resin Infusion Method

450 g of the coated woven glass filament fabric described are impregnated by means of conventional infusion technology with 550 g (39.3 mg/cm²) (Epikote® 03957—mixture of bisphenol A diglycidyl ether and hexahydrophthalic anhydride; product available from Hexion Specialty Chemicals Inc.):

For this purpose, the dry woven glass filament fabric is placed into a glass plate coated with release agent. The fabric is covered with a woven or film release sheet, facilitating the uniform flow of the liquid resin mixture. In addition a membrane is placed onto the fiber stack. By attachment of a sealing strip, the film is sealed against the glass plate, and so the fabric is evacuated by means of a vacuum pump (rotary slide pump). On one side of the vacuum construction, a container containing the described liquid resin mixture is then attached by means of a hose. This resin mixture is subsequently pressed into the fabric by the reduced pressure applied. When the fabric is fully impregnated with the liquid resin mixture, the assembly is cured by supply of heat (8 hours at 80° C. in an oven).

The working example indicated was carried out on the laboratory scale and has been confirmed by large-scale industrial trials.

The product is a fiber-reinforced product which has been produced by the infusion method and which possesses improved properties in terms of transverse tensile strength and fracture toughness.

1. A reinforcement comprising a surface and whose surface has a coating of a composition on the surface, wherein, characterized in that the coating composition comprises is composed of a solid resin, which is optionally self-crosslinking, and carbon nanotubes, and wherein and this the coating composition has been subjected to a heat treatment above the melting temperature or the softening range and below the crosslinking temperature of the optionally self-crosslinking solid resin, which is optionally self-crosslinking, whereby as a result of which the composition is fixed on the surface of the reinforcement.

2. A reinforcement comprising a surface and a coating composition on the surface, wherein the coating composition comprises a solid resin, which is optionally self-crosslinking and has a Tₘ or T_{g}>50° C., carbon nanotubes, and further additives, and wherein the coating composition has been subjected to a heat treatment above the melting temperature or the softening range of the solid resin and below the crosslinking temperature of the optionally crosslinking coating composition, the coating composition being fixed on the surface of the reinforcement.

3. The reinforcement of claim 1 wherein the solid resin is selected from epoxy resins, phenoxy resins, vinyl ester resins, polyester resins, cyanate ester resins, bismaleimide resins, benzoxazine resins and mixtures hereof.

4. The reinforcement of claim 3, wherein the coating composition comprises at least one resin selected from the group consisting of polyepoxides on the basis of bisphenol A and/or F and advancement resins prepared therefrom, on the basis of epoxidized halogenated bisphenols epoxidized novolaks or polyepoxide esters,on the basis of phthalic acid, hexahydrophthalic acid, on the basis of terephthalic acid, epoxidized o- or p-aminophenols, epoxidized polyaddition products of dicyclopentadiene and phenol and combinations thereof.

5. The reinforcement of claim 1 wherein the carbon nanotubes are present in a concentration of 0.2% to 30% by weight, based on the solid resin, in the composition.

6. The reinforcement of claim 2, characterized in that the wherein the coating composition comprises, as further additives, graphite powders, siloxanes, pigments, metals or metal oxides, reactive diluents, processing assistants and/or UV protectants.

7. The reinforcement of claim 2, characterized in that the wherein the coating composition comprises, as further additive, a crosslinking agent.

8. The reinforcement of claim 1 wherein at least one of the preceding claims, characterized in that the reinforcement is selected from fibers, scrims, nonwovens, knits, random-laid fiber mats and/or wovens.

9. The reinforcement of claim 1 wherein at least one of the preceding claims, characterized in that the reinforcement is selected from glass, ceramic, boron, carbon, basalt, synthetic and/or natural polymers.

10. The use of a coated reinforcement of at least one of the preceding claims for producing products for industrial applications, for producing rotor blades for wind turbines, in aircraft and vehicle technology, in automobile construction, for sports articles, and in marine construction.

11. A method for producing a fiber-reinforced product, comprising the following steps:
a) producing a the coated reinforcement of claim 1 to provide a coated reinforcement at least one of claims 1 to 8 and optionally preforming in one or more layers of the coated reinforcement,
b) contacting the coated reinforcement with a resin which is liquid at processing temperatures, and
c) curing the assembly at optionally elevated temperature under increased or reduced pressure.

12. The method of claim 11 wherein 10, characterized in that the fiber-reinforced product is produced by a the Resin Transfer Molding (RTM) process.

13. The method of claim 11 wherein the fiber-reinforced product is produced by a vacuum infusion method.

14. The method of claim 11 wherein the liquid resin is selected from epoxy resins, phenoxy resins, vinyl ester resins, polyester resins, cyanate ester resins, bismaleimide resins, benzoxazine resins and/or mixtures hereof.
